(19) United States
(12) Patent Application Publication
(10) Pub. No.: US 2024/0409095 A1
(43) Pub. Date: Dec. 12, 2024

(54) INFORMATION PROCESSING DEVICE

(71) Applicant: TOYOTA JIDOSHA KABUSHIKI KAISHA, Toyota-shi, Aichi-ken (JP)

(72) Inventors: Yusuke YAMAURA, Meguro-ku, Tokyo (JP); Shintaro FUKUSHIMA, Bunkyo-ku, Tokyo (JP); Takeyuki SASAI, Toshima-ku, Tokyo (JP); Yuta FUKASAWA, Setagaya-ku, Tokyo (JP); Koichi SEKI, Saitama-shi, Saitama-ken (JP); Jiawei YONG, Kawasaki-shi, Kanagawa-ken (JP); Yuho YOKOI, Bunkyo-ku, Tokyo (JP)

(73) Assignee: TOYOTA JIDOSHA KABUSHIKI KAISHA, Toyota-shi, Aichi-ken (JP)

(21) Appl. No.: 18/439,954

(22) Filed: Feb. 13, 2024

(30) Foreign Application Priority Data
Apr. 12, 2023 (JP) 2023-065064

(51) Int. Cl. B60W 30/18

(52) U.S. Cl. CPC B60W 30/18154

(57) ABSTRACT

An information processing device that generates information regarding vehicle driving, the information processing device periodically estimating a factor causing a first vehicle to stop based on information collected from a second vehicle preceding the first vehicle., determining whether or not the first vehicle needs to stop and the stopping position based on the result of the estimation; and when it is determined that the first vehicle needs to stop at the stopping position, the first vehicle It has a control unit that generates a driving plan including a deceleration pattern for stopping the vehicle at a stopping position, and executes the following, and the control unit is configured to shorten the estimation cycle when the certainty of the estimation is lower.

### CROSS-REFERENCE TO RELATED APPLICATION

This application claims priority to Japanese Patent Application No. 2023-065064 filed on Apr. 12, 2023, incorporated herein by reference in its entirety.

### BACKGROUND

### 1. Technical Field

The present disclosure relates to driving assistance of a vehicle.

### 2. Description of Related Art

Many technologies related to driving assistance of vehicles are known. Regarding this, for example, Japanese Unexamined Patent Application Publication No. 2017-004105 (JP 2017-004105 A) discloses a driving assistance device and so forth that, when determination is made that a vehicle is in a dangerous driving state and the vehicle should be stopped, identify a time period for performing regenerative braking or coasting. Note that whether the vehicle is in a dangerous driving state is determined when the vehicle enters an intersection, based on distance to the intersection, speed of the vehicle, and signal information.

### SUMMARY

As machine learning continues to develop, usage of driving assistance technology based on analysis of data collected from vehicles is expected to increase even further in the future.

It is an object of the present disclosure to perform optimal deceleration control of a vehicle, in accordance with surrounding conditions.

One aspect of the embodiment of the present disclosure is an information processing device that generates information regarding driving of a vehicle, the information processing device including a control unit that executes periodically estimating, based on information collected from a second vehicle traveling ahead of a first vehicle, a factor causing the first vehicle to stop, determining necessity of the first vehicle to stop, and a stopping position, based on a result of the estimating, and generating a driving plan including a deceleration pattern for the first vehicle to stop at the stopping position, when determination is made that the first vehicle needs to stop at the stopping position.

The control unit sets a cycle of the estimating to be shorter when certainty of the estimating is lower.

Further, other aspects include a method executed by the above device, a program for causing a computer to execute the method, and a computer-readable storage medium that non-transitorily stores the program.

According to the present disclosure, optimal deceleration control of the vehicle can be performed in accordance with the surrounding situation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of processing executed by an information processing device;

FIG. 2 is a diagram illustrating components included in a system including an information processing device according to an embodiment;

FIG. 3 is a flowchart of estimation processing executed by the control unit of the information processing device according to the embodiment;

FIG. 4 is a flowchart of the process of stopping the first vehicle executed by the control unit 110 of the information processing device 100 according to the embodiment; and

FIG. 5 is a flowchart of a process of updating a master pattern based on certainty level, which is executed by the control unit 110 of the information processing device 100 according to the embodiment.

### DETAILED DESCRIPTION OF EMBODIMENTS

Driving support devices are known that support deceleration of a vehicle in accordance with the situation of an intersection ahead, etc., in order to achieve low fuel consumption.

For example, consider a case where information regarding traffic signals is received from a beacon installed at an intersection and vehicle deceleration control is performed. For example, if the vehicle is expected to stop, such as when the traffic light ahead is red, cutting acceleration in advance can increase coasting and improve fuel and electricity consumption.

However, in this case, in a place where a beacon is not installed, the vehicle cannot receive information necessary for deceleration control, such as information regarding traffic signals, and therefore cannot perform deceleration control of the vehicle.
In order to achieve low fuel consumption, it is desirable to be able to control the deceleration of a vehicle without being restricted by location, even at locations other than specific locations such as intersections.

For this reason, systems have been devised that predict the surrounding situation based on information received from other vehicles, rather than using beacons installed at intersections or the like, and determine whether or not a stop is necessary. For example, if there are many vehicles stopped at an intersection ahead, it can be predicted that a stop will occur due to a red light.

However, in this case, there is a problem in that the prediction accuracy is lower than when using beacons. In order to improve prediction accuracy, it is necessary to communicate with more vehicles more frequently, but this creates another problem: increased communication costs.

In the present disclosure, this problem is solved by adaptively estimating a vehicle stop factor according to prediction uncertainty.

An information processing device according to an aspect of the present disclosure is an information processing device that generates information related to driving of a vehicle, and includes a control unit that executes: periodically estimating a factor of stop of the first vehicle based on information collected from the second vehicle preceding the first vehicle; determining whether the first vehicle needs to stop and the stop position based on the estimation result; and generates a drive plan including a deceleration pattern for stopping the first vehicle at the stop position when determination is made that the first vehicle needs to stop at the stop position. The control unit sets the period of the estimation to be shorter when the certainty of the estimation is lower.

The first vehicle is a vehicle to which the information processing device performs driving support or control. The information processing device estimates the factor causing the first vehicle stopping. Furthermore, a driving plan including an optimal deceleration pattern for the first vehicle is generated based on the estimation result. By applying such a driving plan to the first vehicle, the information processing device can cut unnecessary acceleration. Alternatively, the information processing device can start deceleration at an appropriate timing.

The second vehicle is a vehicle that runs ahead of the first vehicle. The second vehicle has a communication function. The second vehicle can transmit information regarding the driving state of the own vehicle to the information processing device.

The control unit periodically estimates a factor causing the first vehicle to stop based on information collected from a second vehicle preceding the first vehicle. The control unit determines whether or not the first vehicle needs to be stopped and the stopping position based on the estimation result. Furthermore, when it is determined that the first vehicle needs to stop at the stopping position, the control unit generates a driving plan that includes a deceleration pattern for stopping the first vehicle at the stopping position.

The factor that causes the first vehicle to stop is, for example, a red light or a traffic jam. The stopping position is, for example, a stop line at an intersection, the end of a line of vehicles stopped at a red light, or the end of a line of cars stopped due to traffic congestion. The stopping position may be a relative position with respect to the first vehicle, or may be an absolute position represented by latitude and longitude information. The deceleration pattern represents, for example, the relationship between the speed of the first vehicle and the elapsed time (or travel distance). The deceleration pattern may be composed of a plurality of periods, such as a period of deceleration and a period of coasting.

Furthermore, the control unit sets the estimation cycle to be shorter when the certainty of estimating the factor causing vehicle stopping is lower. As a result, it becomes possible to estimate the cause of the stoppage based on newer information, and the accuracy of the estimation can be improved. According to this configuration, it is possible to reduce the cost of communication and processing in the device that estimates the cause of the stoppage based on the information collected from the second vehicle.

Further, the information processing device may store a master pattern, which is an ideal deceleration pattern up to the stopping position, in association with the geographical position of the stopping position. The control unit may then generate a driving plan using the master pattern corresponding to the determined geographical location of the stopping position.

Thereby, for example, the information processing device can generate a driving plan using a deceleration pattern according to the characteristics of the location. Therefore, the information processing device can generate a driving plan for appropriate deceleration control of the vehicle depending on the location where the first vehicle is traveling.

In addition, the control unit responds to the stopping position based on actual deceleration data representing the actual deceleration state of the first vehicle during the period covered by the generated driving plan and the certainty of estimation during the period covered by the driving plan. You may update the master pattern.

The control unit may update the master pattern using the actual deceleration data. At this time, the control unit may adjust the weight for the actual deceleration data depending on the certainty of the estimation.

Further, in updating the master pattern, the control unit may reduce the weight of the actual deceleration data as the certainty of estimation becomes lower.

Thereby, the information processing device can adjust the magnitude of the influence of the actual deceleration data on the generation of the driving plan according to the certainty of the estimation. Therefore, the information processing device can generate a driving plan for vehicle deceleration control that is more in line with the actual situation.

The control unit may set the cycle of the estimation to be shorter when the speed of the first vehicle indicated by the deceleration pattern included in the generated driving plan deviates from the actual speed of the first vehicle by a predetermined value or more than when the speed of the first vehicle indicated by the deceleration pattern does not deviate from the speed of the first vehicle by a predetermined value or more.

If there is a discrepancy between the driving mode assumed in the driving plan and the actual driving mode, there may be an error in estimating the cause of the stoppage. Therefore, in such a case, the estimation cycle may be set to be shorter, as in the case where the certainty in estimation is low.

Thereby, the information processing device can generate a driving plan for vehicle deceleration control that is more in line with the actual situation.

Hereinafter, specific embodiments of the present disclosure will be described based on the drawings. Unless otherwise specified, the hardware configuration, module configuration, functional configuration, etc. described in each embodiment are not intended to limit the technical scope of the disclosure.

### First Embodiment

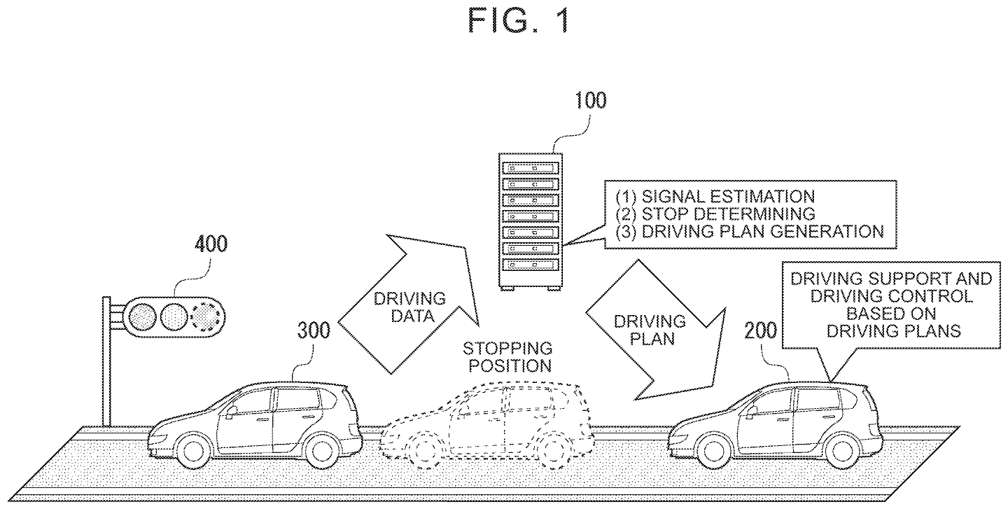

An overview of the processing performed by the information processing device according to the embodiment will be described with reference to FIG. 1. FIG. 1 is a conceptual diagram of processing executed by the information processing device 100. In this embodiment, the information processing device 100 communicates with the first vehicle 200 and generates a driving plan for controlling the deceleration of the first vehicle 200. Further, in order to generate the driving plan, the information processing device 100 also communicates with a second vehicle 300, which is a vehicle that travels in advance of the first vehicle 200, and provides information regarding the driving state of the second vehicle 300. (hereinafter referred to as driving data).

An overview of the processing performed by the information processing device 100 will be described below.

First, the information processing device 100 estimates the cause of the first vehicle 200 stopping. In this embodiment, the factor that causes the first vehicle 200 to stop is a signal. Specifically, the traffic light is a red traffic light. The information processing device 100 periodically communicates with a second vehicle 300 that travels in advance of the first vehicle 200 and acquires travel data from the second vehicle 300. Note that the number of second vehicles 300 is not limited to one, but may be multiple. The information processing device 100 then estimates the state of the traffic light 400 (color of lit lights, etc.) based on the travel data acquired from the second vehicle 300 (corresponding to (1) signal estimation in FIG. 1).

For example, the information processing device 100 may estimate the time when the light of the traffic light 400 switches to green based on the time when the stopped second vehicle 300 starts moving. Further, when some of the plurality of second vehicles 300 passing through an intersection stop at the intersection, the information processing device 100 causes the light of the traffic light 400 to turn red based on the time when the vehicle stopped. The time of switching may be estimated.

When there are multiple second vehicles 300, the information processing device 100 may estimate the time when the light of the traffic light 400 is switched based on the time when each vehicle started or stopped.

Based on the above estimation of the light of the traffic light 400, the information processing device 100 can estimate the cycle of the light of the traffic light 400, etc. For example, the information processing device 100 performs a process of estimating the light cycle of the traffic light 400 for 30 minutes in advance based on information regarding the driving state of the second vehicle 300 for the past 30 minutes at 5-minute intervals. Good too.

In this way, the information processing device 100 may repeatedly perform the process of estimating the cause of the stoppage of the first vehicle 200 at a predetermined cycle.

Next, the information processing device 100 determines whether or not the first vehicle 200 needs to be stopped and the stopping position of the first vehicle 200 (corresponding to (2) stop determination in FIG. 1). That is, the information processing device 100 determines whether the first vehicle 200 needs to stop based on the estimated lighting cycle of the traffic light 400. Then, when the information processing device 100 determines that the first vehicle 200 needs to stop, the information processing device 100 determines the position where the first vehicle 200 should stop.

Then, when the information processing device 100 determines that the first vehicle 200 needs to stop, it generates a driving plan. The driving plan includes a deceleration pattern for stopping the first vehicle 200 to a stopping position. The deceleration pattern may be generated by referring to a table indicating whether or not deceleration is possible, which is determined according to the distance to the stopping position and the current traveling speed.

Information processing device 100 transmits the generated driving plan to first vehicle 200. The first vehicle 200 controls deceleration or provides driving assistance to the driver based on the driving plan. Furthermore, the information processing device 100 updates the driving plan at regular intervals.

As described above, the driving plan is generated based on the result of estimating the state of the traffic light 400 (light cycle). However, depending on the timing of the estimation, correct estimation results may not be obtained. For example, even if it is determined whether the first vehicle 200 needs to stop at the current time based on a signal cycle estimated based on data acquired 30 minutes ago, an accurate result may not be obtained.

Therefore, in the phase of generating a driving plan, the information processing device 100 changes the estimation period according to the certainty level (certainty) of signal estimation. Specifically, the information processing device 100 shortens the estimation cycle as the certainty of signal estimation is lower. Shortening the estimation cycle may mean temporarily shortening a preset predetermined cycle, or may mean immediately re-executing the estimation without waiting for the arrival of the next cycle. good.

According to this configuration, it becomes possible to estimate the cause of the stoppage based on newer information, increasing the possibility that a more appropriate driving plan can be generated.

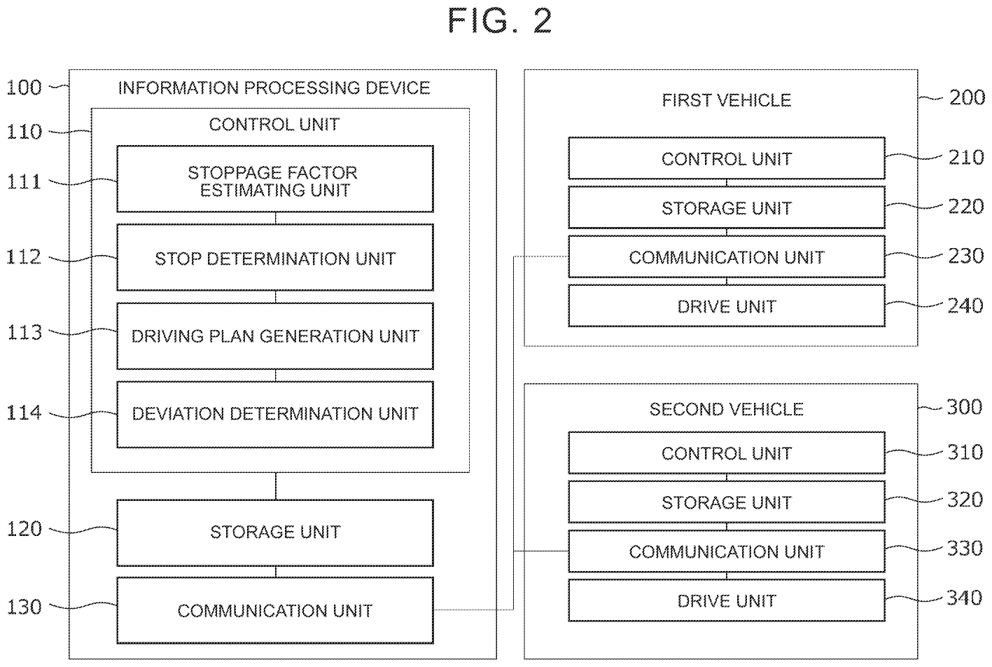

Next, each element constituting the system will be explained in detail. FIG. 2 is a diagram illustrating components included in a system including the information processing device 100 according to the embodiment.

The information processing device 100 according to this embodiment includes a control unit 110, a storage unit 120, and a communication unit 130. The information processing device 100 performs wireless communication with the first vehicle 200 and the second vehicle 300, and acquires information regarding the driving state of the vehicles. Additionally, the information processing device 100 generates a driving plan and transmits the driving plan to the first vehicle 200.

The control unit 110 is implemented by a processor such as a central processing unit (CPU) or a graphics processing unit (GPU) and memory. The control unit 110 includes a stop factor estimation unit 111, a stop determination unit 112, a driving plan generation unit 113, and a deviation determination unit 114 as functional modules. These functional modules may be realized by executing programs by the control unit 110.

Stopping factor estimating section 111 periodically estimates a factor causing first vehicle 200 to stop (stopping factor) based on information collected from second vehicle 300.

The factor that causes the first vehicle 200 to stop is, for example, a traffic light (red light) or a traffic jam. The stop factor estimating unit 111 estimates conditions (hereinafter also referred to as surrounding conditions) related to factors that cause the first vehicle 200 to stop, such as the lighting cycle of a traffic light (red light) and a traffic jam section.

For example, the stop factor estimating unit 111 may predict the lighting cycle of the traffic light 400 based on information (driving data) regarding the driving state of the vehicle acquired from the second vehicle 300. The information processing device 100 may then estimate the time when the red light of the traffic light 400 will turn on based on the prediction. Alternatively, the stop factor estimating unit 111 may acquire information regarding the section where the traffic jam occurs and the position where the second vehicle 300 starts decelerating, and may predict the end position of the traffic jam.

The stop determination unit 112 determines whether the first vehicle 200 needs to stop based on the surrounding situation estimated by the stop factor estimation unit 111. Further, the stop determination unit 112 determines the position at which the first vehicle 200 should stop based on the surrounding situation estimated by the stop factor estimation unit 111.

For example, when the first vehicle 200 enters near an intersection where a traffic light 400 is present, the stop determination unit 112 determines whether the traffic light 400 is activated based on the time when the red light turns on, which is estimated by the stop factor estimation unit 111. It may also be determined whether a red light is on. When the first vehicle 200 approaches the vicinity of the intersection, if it is determined that the red light of the traffic light 400 is on, the stop determination unit 112 determines that the first vehicle 200 has stopped at the intersection. It is determined that it is necessary to do so. When determining that the first vehicle 200 needs to stop at the intersection, the stop determination unit 112 also determines the position where the first vehicle 200 should stop. The position at which the first vehicle 200 should stop may be, for example, a relative position from the point where the first vehicle 200 is traveling, or an absolute position represented by latitude and longitude information.

The driving plan generation unit 113 generates a driving plan including a deceleration pattern for the first vehicle 200 to stop at the stopping position. The deceleration pattern may be generated by referring to a table that indicates whether the accelerator should be off or the brakes on, which is discretized at equal intervals according to the distance to the stopping position and the current traveling speed. good. The table may be generated, for example, based on actual deceleration data representing the actual deceleration state of the first vehicle 200 in the past.

The driving plan generation unit 113 periodically generates a driving plan based on data provided from the stoppage factor estimation unit 111 and the stop determination unit 112. This period is a preset value (for example, 5 minutes). However, this cycle can be dynamically changed by the driving plan generation unit 113, as explained below.

In this embodiment, the driving plan generation process performed by the driving plan generation unit 113 is executed independently of the stoppage factor estimation process performed by the stoppage factor estimation unit 111. However, the driving plan generation unit 113 can also change the period of the stoppage factor estimation process performed by the stoppage factor estimation unit 111, as necessary.

For example, if the certainty of the estimation of the cause of the first vehicle 200 stopping, which is used to generate the driving plan, is lower, the driving plan generating unit 113 may request the stopping factor estimating unit 111 to have a shorter period. instructs to perform estimation processing. Furthermore, the driving plan can be regenerated using the estimation results obtained thereby.

The generated driving plan including the deceleration pattern is transmitted to the vehicle control system of the first vehicle 200. The first vehicle 200 executes control of its own vehicle (for example, accelerator off control, control to operate the brake and start deceleration, etc.) according to the deceleration pattern. Note that although an example has been given here in which the first vehicle 200 autonomously controls the speed, the driving plan may be used to support driving operations by the driver. For example, a deceleration plan may be displayed on the in-vehicle terminal.

The deviation determination unit 114 determines the speed of the first vehicle 200 indicated by the deceleration pattern included in the driving plan generated by the driving plan generating unit 113 and the speed of the first vehicle 200 indicated by the actual deceleration data of the first vehicle 200. It is determined whether or not they deviate by a predetermined value or more. That is, the deviation determination unit 114 determines whether the first vehicle 200 is traveling according to the generated driving plan.

If the speed of the first vehicle 200 indicated by the deceleration pattern and the actual speed of the first vehicle 200 deviate by more than a predetermined value, the driver of the first vehicle 200 may intervene in the vehicle control., means that the first vehicle 200 is not decelerating according to the deceleration pattern. In this case, it is presumed that the result of estimating the cause of the stoppage is incorrect. Therefore, in such a case, the driving plan generation unit 113 sets the period of estimation performed by the stop factor estimation unit 111 to be shorter in order to improve the accuracy of estimation.

The storage unit 120 is a main storage device such as RAM or ROM, an auxiliary storage device such as an EPROM, a hard disk drive, and a removable medium. The auxiliary storage device stores an operating system (OS), various programs, various tables, etc., and by executing the programs stored there, realizes each function that matches the predetermined purpose of each part of the control unit 110. can do. However, some or all of the functions may be realized by a hardware circuit such as an ASIC or FPGA.

The storage unit 120 stores data used or generated in the processing performed by the control unit 110. Furthermore, the storage unit 120 may store data necessary for generating a driving plan, such as map data acquired from an external device.

The communication unit 130 is composed of a communication circuit that performs wireless communication. The communication unit 130 may be, for example, a communication circuit that performs wireless communication using 4th Generation (4G) or a communication circuit that performs wireless communication using 5th Generation (5G). Further, the communication unit 130 may be a communication circuit that performs wireless communication using Long Term Evolution (LTE), or may be a communication circuit that performs communication using Low Power Wide Area (LPWA). Furthermore, the communication unit 130 may be a communication circuit that performs wireless communication using Wi-Fi (registered trademark).

Next, devices other than the information processing device 100 will be explained.

First vehicle 200 is typically a passenger car. The first vehicle 200 may be a bus, a truck, or the like. The first vehicle 200 performs wireless communication with the information processing device 100. The first vehicle 200 includes a control unit 210, a storage unit 220, a communication unit 230, and a drive unit 240.

The control unit 210 transmits information regarding the driving state of the host vehicle to the information processing device 100 via the communication unit 230. Further, the control unit 210 receives a driving plan from the information processing device 100 via the communication unit 230. Then, the control unit 210 controls the driving of the first vehicle 200 or supports the driver's driving via the drive unit 240 based on the driving plan.

The control unit 210 is realized by a processor such as a CPU or a GPU, and memory. The functions of the control unit 210 described above may be realized by executing a program by the control unit 210.

The storage unit 220 is a main storage device such as RAM or ROM, an auxiliary storage device such as an EPROM, a hard disk drive, and a removable medium. The auxiliary storage device stores an operating system (OS), various programs, various tables, etc., and by executing the programs stored there, realizes each function that matches the predetermined purpose of each part of the control unit 110. can do. However, some or all of the functions may be realized by a hardware circuit such as an ASIC or FPGA.

The storage unit 220 stores data and the like that are used or generated in the processing performed by the control unit 210. Furthermore, the storage unit 220 may store data necessary for controlling the driving of the first vehicle 200 or data necessary for driving support for the driver. These data are, for example, map data obtained from an external device.

The communication unit 230 is composed of a communication circuit that performs wireless communication. The communication unit 230 may be, for example, a communication circuit that performs wireless communication using 4G or a communication circuit that performs wireless communication using 5G. Furthermore, the communication unit 230 may be a communication circuit that performs wireless communication using LTE, or may be a communication circuit that performs communication using LPWA. Further, the communication unit 230 may be a communication circuit that performs wireless communication using Wi-Fi (registered trademark).

The drive unit 240 is a means for driving the first vehicle 200. The drive unit 240 can be configured to include, for example, a motor for driving wheels, an inverter, a brake, and a steering mechanism. The drive unit 240 may be operated by power supplied from a battery.

Second vehicle 300 is typically a passenger car. The first vehicle 200 may be a bus, a truck, or the like. The first vehicle 200 performs wireless communication with the information processing device 100.

Second vehicle 300 includes a control unit 310, a storage unit 320, a communication unit 330, and a drive section 340. Each component of second vehicle 300 is similar to first vehicle 200.

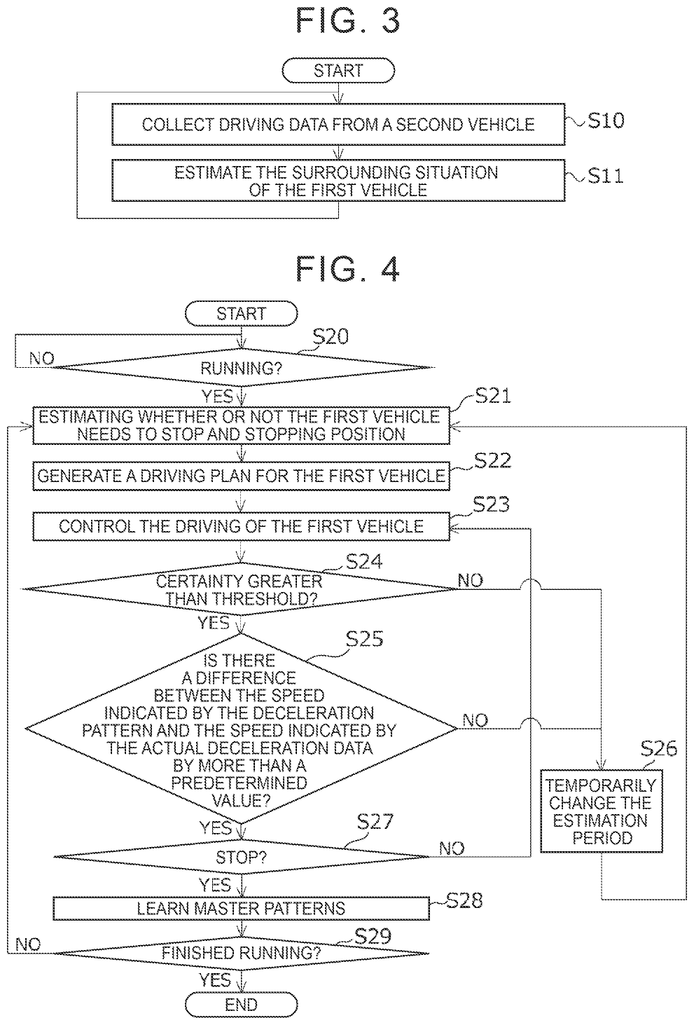

Next, specific details of the processing performed by the information processing device 100 will be described. FIG. 3 is a flowchart of the estimation process (process of estimating the surrounding situation) executed by the control unit 110 of the information processing device 100 according to the embodiment. The illustrated process is repeatedly executed at a predetermined cycle.

In S10, the stop factor estimating unit 111 acquires travel data from the second vehicle 300 that travels in advance of the first vehicle 200. Stop factor estimating unit 111 may acquire travel data from a plurality of second vehicles 300. Stop factor estimating section 111 acquires travel data of second vehicle 300 from second vehicle 300 and stores it in storage unit 120.

Next, in S11, the stop factor estimating unit 111 estimates the surrounding situation of the first vehicle 200 using the acquired travel data of the second vehicle 300. The surrounding situation of the first vehicle 200 is a situation related to the cause of the first vehicle 200 stopping, and is the color of the lit light of the traffic light 400 at the intersection located in front of the first vehicle 200, or it may be a light cycle. The light cycle may include the period (number of seconds) during which each of the plurality of lights light up, the time at which the lights change, and the like. For example, the stop factor estimation unit 111 estimates the time when the light of the traffic light 400 changes to red or green at an intersection.

Alternatively, the stop factor estimating unit 111 may predict the tail end of a traffic jam located in front of the first vehicle 200 as the surrounding situation of the first vehicle 200.

After S11, the stop factor estimation unit 111 performs the process of S10 again. In this manner, the stop factor estimating unit 111 periodically collects travel data from the second vehicle 300 and estimates the surrounding situation of the first vehicle 200. The cycle of this process may be determined in advance. For example, the period is every 5 minutes. Alternatively, the period may be changed by an external trigger. For example, if the stop factor estimating unit 111 receives an instruction from the driving plan generation unit 113 while periodically performing estimation at predetermined intervals such as 5-minute intervals, the stop factor estimating unit 111 may start the next estimation process immediately without having 5-minute intervals.

Further, the stop factor estimating unit 111 calculates the certainty of the estimation when performing the estimation process in S11. The stop factor estimating unit 111 calculates the estimation based on the weighted sum of the certainty output by the estimation algorithm, the certainty calculated according to predictable factors, and the certainty of unpredictable factors. Uncertainty may also be calculated.

Here, the certainty level output by the estimation algorithm is a value indicating a deviation between the estimated model and actual data, such as a squared error in the estimated model. In addition, the certainty calculated according to a predictable factor is, for example, when the stop factor estimating unit 111 estimates the lighting cycle of a signal, the lighting cycle of a time-varying signal, a push button type or a sensitive type traffic light 400 method or from predictable factors such as the small amount of traffic on the road to be estimated. In addition, when the stop factor estimation unit 111 estimates the lighting cycle of a traffic signal, the certainty of unpredictable factors includes the behavior of surrounding vehicles such as lane changes or parking on the street, accidents, breakdowns, or pedestrians jumping out. This is the certainty level calculated from unpredictable factors such as sudden events such as

Alternatively, when the stop factor estimating unit 111 estimates the presence or absence of traffic congestion, the certainty calculated according to predictable factors means that the driving lane of the vehicle for which information is collected cannot be specified from among multiple driving lanes., the fact that there are fewer vehicles running, or the difference between the predicted time and the current time. In addition, when the stop factor estimating unit 111 estimates the presence or absence of traffic congestion, the certainty of unpredictable factors includes the behavior of surrounding vehicles such as stopping at traffic lights or parking on the street, accidents, breakdowns, and pedestrians jumping out. This is the certainty level calculated from unpredictable factors such as sudden events such as

The certainty level may change depending on the freshness of the information used for estimation. For example, the older the information used for estimation (e.g., travel data collected from second vehicle 300), the lower the certainty level may be. The certainty level is provided to the stop determination unit 112 and the driving plan generation unit 113 together with the estimation result.

FIG. 4 is a flowchart of a process for stopping the first vehicle 200, which is executed by the control unit 110 of the information processing device 100 according to the embodiment.

Note that the information processing device 100 stores in advance a master pattern of the deceleration pattern in the storage unit 120 in association with the geographical position of the stopping position. That is, the information processing device 100 stores a typical deceleration pattern corresponding to the stopping position in the storage unit 120 as a master pattern. Here, the geographical position refers to an absolute position expressed using latitude and longitude information. A typical deceleration pattern corresponding to the stopping position may be generated by taking into account road characteristics such as the road gradient at the stopping position. Note that although the master pattern is stored in association with the stopping position here, the master pattern may be a common pattern regardless of the geographical location.

In S20, the stop determination unit 112 determines whether the first vehicle 200 is traveling. In this step, if the stop determination unit 112 determines that the first vehicle 200 is traveling, an affirmative determination is made. If an affirmative determination is made in S20, the process transitions to S21. Further, if a negative determination is made in S20, the process transitions to S20. That is, S20 is repeated.

Next, in S21, the stop determination unit 112 estimates whether or not the first vehicle 200 needs to be stopped and the stopping position. Specifically, the stop determination unit 112 determines whether or not the red light of the traffic light 400 is on at the timing at which the first vehicle 200 enters the intersection in the intersection where the first vehicle 200 enters next. That is, the stop determination unit 112 determines whether the first vehicle 200 needs to stop at the intersection. In addition, the stop determination unit 112 determines a stopping position where the first vehicle 200 should stop.

Next, in S22, driving plan generation unit 113 generates a driving plan for first vehicle 200. The driving plan includes a deceleration pattern based on the current speed of the first vehicle 200 and the distance to the stopping position. The deceleration pattern includes the time (distance) of the deceleration section to the stopping position, the time (distance) of the coasting section, etc.

In this embodiment, a typical deceleration pattern of the first vehicle 200 is stored in the storage unit 120, and the driving plan generation unit 113 acquires the stored deceleration pattern and uses it for controlling the vehicle. This pre-stored deceleration pattern is called a master pattern. A master pattern is stored for each target stopping position (for example, for each intersection).

In S22, the driving plan generation unit 113 generates a driving plan using the master pattern corresponding to the geographical location of the stopping position. The driving plan generation unit 113 may generate a driving plan by reflecting the actual speed of the first vehicle 200 on the master pattern corresponding to the geographical position of the stopping position.

Note that if the master pattern corresponding to the target stopping position is not recorded in the storage unit 120, the driving plan generation unit 113 generates a reference master pattern based on information such as road characteristics of the target stopping position. The deceleration pattern obtained by the correction may be used. Here, the road characteristics include road slope and the like.

Next, in S23, the control unit 210 of the first vehicle 200 controls the drive unit 240 of the first vehicle 200. As a result, control of the traveling of the first vehicle 200 or driving support for the driver is started. Control unit 210 of first vehicle 200 may decelerate first vehicle 200 according to a deceleration pattern included in the driving plan. Alternatively, the control unit 210 of the first vehicle 200 may assist the driver driving the first vehicle 200 so that the driver can decelerate according to the deceleration pattern included in the driving plan.

Next, in S24, the driving plan generation unit 113 determines whether the certainty of the estimation performed in S11 is greater than a predetermined threshold. If the driving plan generation unit 113 determines that the certainty level of the estimation is greater than the predetermined threshold, an affirmative determination is made in this step, and the process transitions to S25.

If the certainty of the estimation is smaller than the predetermined threshold, a negative determination is made in this step, and the process shifts to S26.

When the process transitions to S26, the driving plan generation unit 113 temporarily changes the cycle of the estimation process performed by the stop factor estimation unit 111, which was described with reference to FIG. 3. For example, the driving plan generation unit 113 interrupts the estimation batch processing performed at intervals of 5 minutes, etc., and uses newly acquired data up to that point to estimate the surrounding situation and estimate the stop factor. The unit 111 may perform the process again. Thereby, the period of estimation processing can be temporarily shortened.

Note that in the above example, the driving plan generation unit 113 immediately causes the stop factor estimation unit 111 to perform the estimation process again, but the present disclosure is not limited to this form. For example, the driving plan generation unit 113 may instruct the stop factor estimating unit 111 to temporarily shorten the estimation period depending on the certainty level of the estimation. For example, the driving plan generation unit 113 may set the estimation cycle to be longer as the certainty level is higher, and may set the estimation cycle to be shorter as the certainty level is lower. The frequency of estimation may be defined as a function proportional to the certainty level.

Note that, as a result of executing S26, if the stop factor estimating unit 111 performs a new estimation, the driving plan generation unit 113 may regenerate the driving plan using the result of the newly performed estimation. good.

In this manner, in this embodiment, when the certainty level is lower than the threshold value, the driving plan generation unit 113 temporarily sets the cycle of the surrounding situation estimation process performed by the stop factor estimation unit 111 to be short. Since the estimation is performed using data newly acquired after the previous estimation was performed, the certainty of the estimation can be improved. This is because the more recently collected travel data from the second vehicle 300 is used, the more accurate the determination of the stopping position and the estimation of the time to reach the stopping position are.

If an affirmative determination is made in S24 and the process transitions to S25, the deviation determination unit 114 determines whether the speed indicated by the deceleration pattern included in the driving plan and the speed indicated by the actual deceleration data deviate by a predetermined value or more. Determine. If the deviation determination unit 114 determines that the speed indicated by the deceleration pattern included in the driving plan and the speed indicated by the actual deceleration data deviate by a predetermined value or more, an affirmative determination is made in this step.

If an affirmative determination is made in S25, the process transitions to S27.

If a negative determination is made in S25, the process transitions to S26.

When the process transitions from S25 to S26, the driving plan generation unit 113 temporarily changes the estimation cycle as described above. For example, the driving plan generation unit 113 sets the estimation period shorter than when the speed indicated by the deceleration pattern included in the driving plan and the speed indicated by the actual deceleration data do not deviate by more than a predetermined value. Note that the driving plan generation unit 113 may instruct the stop factor estimation unit 111 to immediately start the next estimation process.

When the process transitions to S27, the control unit 210 of the first vehicle 200 determines whether the first vehicle 200 has stopped. If the control unit 210 determines that the first vehicle 200 has stopped, an affirmative determination is made in this step.

If an affirmative determination is made in S27, the process transitions to S28.

If a negative determination is made in S27, the process transitions to S23.

When the process transitions to S28, the driving plan generation unit 113 generates a plan corresponding to the geographical position of the stopping position based on data representing the change in vehicle speed (actual deceleration data) obtained up to the stop. Update master pattern.

The master pattern is updated, for example, based on the actual deceleration data obtained while driving from 300 m before the traffic light 400 to the stopping position, or from 20 seconds before the stop to the stop, based on the deceleration included in the driving plan. This may be done by learning the optimal value of the pattern. Alternatively, the driving plan generation unit 113 may update the master pattern while driving to the end of the predicted traffic jam for 300 m, or update the master pattern based on the actual deceleration data from 20 seconds before the stop until the stop. This may be done by learning the optimal value of the deceleration pattern. This makes it possible to obtain an optimal deceleration pattern depending on road characteristics such as slope.

Note that the driving plan generation unit 113 may select a suitable learning method from among a plurality of learning methods depending on the certainty of the estimation used to generate the driving plan generated in S22. Specifically, when the certainty of the estimation used for the driving plan is high, the driving plan generation unit 113 may perform online learning. If the certainty of the estimation used in the driving plan is low, the driving plan generation unit 113 performs batch processing during learning, and after learning with the actual deceleration data when using the result of the estimation with low certainty, Re-learning may be performed using actual deceleration data obtained when estimation results with high certainty are used.

Further, the driving plan generation unit 113 may switch the learning method depending on the amount of data that can be used. For example, when there is a large amount of data that can be used, the driving plan generation unit 113 may use only actual deceleration data for which the estimation certainty is high for learning. When the amount of data that can be used is small, the driving plan generation unit 113 may perform learning by combining a plurality of learning methods, including the above-mentioned learning methods, and may utilize as much data as possible.

Further, the driving plan generation unit 113 may expand the types of data used to generate the driving plan if the certainty of the estimation used during the period in which the actual deceleration data was acquired is low. Specifically, in this case, the driving plan generation unit 113 uses past estimation results such as the latest estimation results, past estimation results on the same day of the week, and the same time period, in addition to the current estimation results, to generate the estimation may be performed to improve the certainty of the estimation.

Next, details of the process of updating the master pattern based on the certainty level will be explained. As described above, the master pattern is updated with actual deceleration data.

On the other hand, if the certainty when estimating the cause of a stop is low, the necessity of stopping and the estimated stopping position may be incorrect, so it may not be appropriate to update the master pattern using actual deceleration data. There is.

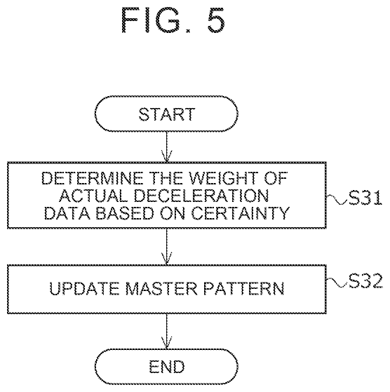

Therefore, the information processing device 100 may update the master pattern after giving weight to the actual deceleration data according to the certainty of the estimation. FIG. 5 is a flowchart of a process of updating a master pattern based on certainty level, which is executed by the control unit 110 of the information processing device 100 according to the embodiment. The process explained in FIG. 5 shows in detail the process executed in S28 of FIG. 4.

First, in S31, the driving plan generation unit 113 determines the weight of the actual deceleration data of the corresponding period used for master pattern learning, based on the certainty of the estimation used in the period in which the actual deceleration data was acquired. do. For example, the driving plan generation unit 113 may reduce the weight of the actual deceleration data of the corresponding period used for learning the master pattern, the lower the certainty of the estimation used in the period in which the actual deceleration data was acquired. good.

Next, in S32, the driving plan generation unit 113 updates the master pattern of the deceleration pattern using the weight of the actual deceleration data determined in S20. Returning to FIG. 4, the explanation will be continued.

When the process transitions to S29, the control unit 210 of the first vehicle 200 determines whether the first vehicle 200 has finished traveling. If the control unit 210 determines that the first vehicle 200 has finished traveling, an affirmative determination is made in this step.

If an affirmative determination is made in S29, the process ends. If a negative determination is made in S29, the process transitions to S21.

As described above, the information processing device 100 collects information from a traveling vehicle preceding the vehicle to be controlled, and periodically estimates the cause and stopping position of the vehicle to be controlled. The information processing device 100 then generates a driving plan that includes a deceleration pattern that allows the vehicle to be controlled to stop at the stopping position. Further, when the certainty in estimating the stoppage factor is lower than a predetermined value, the information processing device 100 sets the stoppage factor estimation cycle and the driving plan generation cycle to be shorter than the predetermined values. Thereby, the information processing device 100 can appropriately decelerate the vehicle to be controlled.

### Variations

The embodiments described above are merely examples, and the present disclosure may be implemented with appropriate changes within the scope of the gist thereof.

For example, the processes and means described in this disclosure can be implemented in any combination as long as no technical contradiction occurs.

Further, the processing described as being performed by one device may be shared and executed by a plurality of devices. Alternatively, processes described as being performed by different devices may be performed by one device. In a computer system, the hardware configuration (server configuration) that implements each function can be flexibly changed.

The present disclosure can also be realized by supplying a computer program that implements the functions described in the above embodiments to a computer, and having one or more processors included in the computer read and execute the program. Such a computer program may be provided to the computer by a non-transitory computer-readable storage medium connectable to the computer's system bus, or may be provided to the computer via a network. The non-transitory computer-readable storage medium may be any type of disk, such as a magnetic disk (floppy disk, hard disk drive (HDD), etc.), an optical disk (CD-ROM, DVD disk, Blu-ray disk, etc.), Includes read only memory (ROM), random access memory (RAM), EPROM, EEPROM, magnetic cards, flash memory, optical cards, and any type of medium suitable for storing electronic instructions.

What is claimed is:

1. An information processing device that generates information regarding driving of a vehicle, the information processing device comprising a control unit that executes
periodically estimating, based on information collected from a second vehicle traveling ahead of a first vehicle, a factor causing the first vehicle to stop,
determining necessity of the first vehicle to stop, and a stopping position, based on a result of the estimating, and
generating a driving plan including a deceleration pattern for the first vehicle to stop at the stopping position, when determination is made that the first vehicle needs to stop at the stopping position, wherein the control unit sets a cycle of the estimating to be shorter when certainty of the estimating is lower.

2. The information processing device according to claim 1, further comprising a storage unit that stores a master pattern that is an ideal deceleration pattern up to the stopping position, in association with a geographical position of the stopping position, wherein the control unit generates the driving plan using the master pattern corresponding to the geographical position of the stopping position that is determined.

3. The information processing device according to claim 2, wherein the control unit updates the master pattern corresponding to the stopping position, based on actual deceleration data representing an actual deceleration state of the first vehicle during a period corresponding to the driving plan that is generated, and the certainty of the estimating during the period corresponding to the driving plan.

4. The information processing device according to claim 3, wherein, in the updating of the master pattern, the lower the certainty of the estimating is the further the control unit reduces weighting of the actual deceleration data.

5. The information processing device according to claim 1, wherein, when a speed of the first vehicle indicated by the deceleration pattern included in the driving plan that is generated, and an actual speed of the first vehicle deviate by a predetermined value or more, the control unit sets the cycle of the estimating to be shorter than when the speed of the first vehicle indicated by the deceleration pattern and the speed of the first vehicle do not deviate by the predetermined value or more.
